(19) United States
(12) Patent Application Publication
(10) Pub. No.: US 2025/0174994 A1
(43) Pub. Date: May 29, 2025

(54) CONTROLLING GRID COMPONENTS OF AN ELECTRIC POWER GRID

(71) Applicant: Reactive Technologies Limited, Oxford (GB)

(72) Inventors: Jukka ALAKONTIOLA, Oxford (GB); Brian BERRY, Oxford (GB); Marc BORRETT, Oxford (GB)

(21) Appl. No.: 19/040,752

(22) Filed: Jan. 29, 2025

Related U.S. Application Data
(63) Continuation of application No. PCT/EP2023/072044, filed on Aug. 9, 2023.

(30) Foreign Application Priority Data
Aug. 11, 2022 (GB) 2211767.5

(51) Int. Cl. H02J 3/14; H02J 3/38; H02J 3/46

(52) U.S. Cl. CPC H02J 3/14; H02J 3/381; H02J 3/466; H02J 2203/20

(57) ABSTRACT

A method, apparatus, and system for controlling grid components of an electric power grid are disclosed. Each grid component is configured to consume power from and/or provide power to the electric power grid according to a respective predefined function that takes received electric power flow characteristic values as an input. The method comprises obtaining values of a characteristic of electric power flow in the electric power grid; altering the obtained values to generate altered electric power flow characteristic values by inputting the obtained values to a mapping function that maps the predefined function onto a controller function; and transmitting the altered electric power flow characteristic values to the grid components to control the grid components to consume power from and/or provide power to the electric power grid according to the controller function. Also disclosed is a method and apparatus for providing altered electric power flow characteristic values.

### CROSS-REFERENCE TO RELATED APPLICATIONS

This application is a continuation under 35 U.S.C. §120 of International Application No. PCT/EP2023/072044, filed Aug. 9, 2023, which claims priority to GB Application No. 2211767.5, filed Aug. 11, 2022, under 35 U.S.C. §119(a). Each of the above-referenced patent applications is incorporated by reference in its entirety.

### TECHNICAL FIELD

The present invention relates to a method, apparatus, and system for controlling one or more grid components of an electric power grid.

### BACKGROUND

Generated electrical power is distributed to consumers via an electricity distribution network or electric power grid. Electric power grids typically operate at a nominal grid frequency that is uniform throughout a synchronous area of the grid. For example, the UK mains supply nominally operates at 50 Hz AC. Grid operators are usually obliged to maintain the grid frequency to within predefined limits. For example the UK electricity system should be kept within 1% of the nominal 50 Hz grid frequency.

Large capacity power stations, such as nuclear or fossil fuel power stations, use spinning generators with relatively massive rotating parts that are powered to rotate at relatively high speeds at some multiple of the nominal grid frequency (so called spinning generation). In the course of their normal operation, these spinning generators store relatively large amounts of kinetic energy in the weight and speed of their spinning turbines. Small capacity providers, such as wind or solar farms often use DC-connected inverters to supply power to the grid at the nominal grid frequency, and typically store a much smaller amount of kinetic energy, or even no kinetic energy at all.

A change in the balance between provision and consumption of electrical power to the grid (for example, if the total amount of provision cannot meet consumption during high demand periods, or if the provision from a power generator or interconnect fails) leads to a change in the load on the generators. This results in a change of the rotational speed of the spinning generators and a corresponding change in the operating frequency of the grid.

It is also desirable to maintain other electric power flow characteristics of the grid, such as voltage, to within specified limits. This helps provide reliable operation of units connected to the grid.

Electric power grids can employ ancillary services to support the stability of electric power flow in the grid. Ancillary services can include grid components configured to consume electrical power from and/or provide electrical power to the electrical power grid, and whose operation can be controlled in order to assist in keeping the electric power flow characteristic values within the specified limits.

As an example, frequency control or dynamic containment ancillary services can be used to help ensure that the grid frequency remains within specified limits. Such services can include grid components that are connected to the power grid and whose power consumption from and/or provision to the grid can be controlled to assist in keeping the grid frequency within specified limits. When the grid frequency reduces from the nominal value, grid components can be controlled to reduce power consumption from, or increase power provided to, the electric power grid so as to bring the frequency back up to the nominal value. Specifically, this reduction in power consumption and/or increase in power provision reduces the load on the spinning generators, causing them to spin faster, and hence the grid frequency increases. Conversely, when the grid frequency increases from the nominal value, grid components can be controlled to decrease power provision to, or increase power consumption from, the electric power grid so as to bring the frequency back down to the nominal value. Specifically, this decrease in power provision and/or increase in power consumption increases the load on the spinning generators, causing them to spin slower, and hence the grid frequency decreases.

In order to provide the ancillary service, each grid component of an ancillary service can be pre-programmed with how the grid component should operate in response to a given grid characteristic value. As an example, a grid component of a frequency ancillary service may be pre-programmed to start providing a certain amount of electrical power to the grid when the grid frequency is 0.03 Hz below the nominal value. More generally, a grid component can be pre-programmed to consume power from and/or provide power to the electric power grid according to a predefined function, the predefined function taking an electric power flow characteristic value as an input.

From time to time, it may be desirable to change the function according to which a grid component consumes/provides electric power from/to the grid. For example, it may be discovered or decided that whereas grid components have been pre-programmed to start providing a certain amount of electrical power to the grid when the grid frequency is 0.03 Hz below the nominal value, it would actually be more beneficial to grid stability if instead the grid components were programmed to start providing the certain amount of electrical power to the grid when the grid frequency is only 0.015 Hz below the nominal value (as an example). This can be achieved by re-programming each of the grid components with a new function. However, re-programming each of the grid components to operate according to the new function is time consuming and expensive to effect not least as each grid component would require some level of technical intervention and then compliance testing to confirm the technical intervention does indeed meet the revised functional parameters correctly. Further, due to the large amount of time needed to re-program and re-test each grid component, the desired change may only be able to be implemented relatively slowly, which may limit the usefulness and/or functionality of the service against the changing needs of managing the stability of the power system.

It is desirable to mitigate at least some of these drawbacks.

### SUMMARY

According to a first aspect of the present invention, there is provided a method of controlling one or more grid components of an electric power grid, each grid component being arranged to consume electric power from and/or provide electric power to the electric power grid, each grid component being configured to receive respective electric power flow characteristic values from a controller and consume power from and/or provide power to the electric power grid according to a respective predefined function, the predefined function taking the received electric power flow characteristic values as an input, the method comprising, at the controller: obtaining measurement data indicating one or more measured values of a characteristic of electric power flow in the electric power grid; altering the obtained electric power flow characteristic values to generate altered electric power flow characteristic values by inputting the obtained electric power flow characteristic values to a mapping function that maps the predefined function onto a controller function; and transmitting the altered electric power flow characteristic values to the one or more grid components, thereby to control the one or more grid components to consume power from and/or provide power to the electric power grid according to the controller function.

Optionally, the predefined function defines a first trigger point of the electric power flow characteristic value at which the respective grid component is triggered to consume power from and/or provide power to the electric power grid, wherein the controller function defines a second trigger point of the electric power flow characteristic value different to the first trigger point, and wherein transmitting the altered electric power flow characteristic values to the one or more grid components triggers the one or more grid components to consume power from and/or provide power to the electric power grid when the obtained electric power flow characteristic value is at the second trigger point.

Optionally, altering the obtained electric power flow characteristic values is responsive to a detected and/or forecasted change in a grid condition of the electric power grid.

Optionally, the method comprises dynamically varying the alteration of the obtained electric power flow characteristic values in response to one or more detected and/or forecasted changes in a grid condition of the electric power grid.

Optionally, the grid condition comprises inertia, a short circuit ratio, a fault level and/or a system strength of the electric power grid; and/or a frequency, a voltage, a current, a reactive power, one or more oscillations, one or more harmonics, and/or a phase angle of electricity flowing in the electric power grid.

Optionally, the grid condition comprises one or more oscillations of electricity flowing in the electric power grid and wherein dynamically varying the alteration comprises varying the alteration so as to dampen one or more of the oscillations.

Optionally, altering the obtained electric power flow characteristic values is responsive to a time point in a time schedule being reached and/or wherein the method comprises dynamically varying the alteration of the obtained electric power flow characteristic values in response to one or more time points in a time schedule being reached.

Optionally, the method comprises: transmitting, to the one or more grid components, in addition to the altered electric power flow characteristic values, a reparameterization signal configured to cause each of the one or more grid components to change one or more parameters of the predefined function according to which the grid component is configured to consume power from and/or provide power to the electric power grid.

Optionally, each of the one or more grid components has a plurality of selectable predefined functions according to which the respective grid component is configurable to consume power from and/or provide power to the electric power grid, and wherein the method comprises: transmitting to the one or more grid components, in addition to the altered electric power flow characteristic values, a selection signal configured to cause each of the one or more grid components to select, respectively, a predefined function of the plurality of predefined functions, whereby the respective grid component is configured to consume power from and/or provide power to the electric power grid according to the selected predefined function.

Optionally, there are a plurality of the grid components.

Optionally, the method comprises: selecting a first group of one or more of the plurality of grid components; and transmitting the altered electric power flow characteristic values to each grid component of the selected first group.

Optionally, the method comprises: selecting a second group of one or more of the plurality of grid components; and transmitting second altered electric power flow characteristic values to each grid component of the second group of grid components, the second altered electric power flow characteristic values being obtained by inputting the obtained electric power flow characteristic values to a second mapping function that maps the predefined function onto a second controller function, thereby to control the second group of grid components to consume power from and/or provide power to the electric power grid according to the second controller function.

Optionally, selecting the first group of one or more grid components and/or selecting the second group of one or more grid components is based on an area in which the grid components are located.

Optionally, there is a plurality of grid components in the first group and the grid components selected to be in the first group are located in the same area as one another and/or wherein there is a plurality of grid components in the second group and the grid components selected to be in the second group are located in the same area as one another.

Optionally, the first group and/or the second group of grid components are selected based on at least one electric power flow condition in the area in which the grid components of the respective group are located.

Optionally, the first group and/or the second group of grid components are selected based on the area in which the grid components of the respective group are located being an area in which a response to a change in grid condition of the electric power grid is determined to be required or is determined to be likely to be effective.

Optionally, obtaining the one or more electric power flow characteristic values comprises, at the controller: obtaining a plurality of measurements of electric power flow characteristic values taken at a respective plurality of different locations in the electric power grid; and combining the plurality of measurements to determine the obtained electric power flow characteristic values.

Optionally, the electric power flow characteristics is indicative of one or more of inertia, a short circuit ratio, a fault level, and/or a system strength of the electric power grid; and/or a frequency, a voltage, a current, a reactive power, one or more oscillations, one or more harmonics, and/or a phase angle, of electricity flowing in the electric power grid.

Optionally, the power that is consumed from and/or provided to the electric power grid by the one or more grid components is active power and/or reactive power.

Optionally, the power that is consumed from and/or provided to the electric power grid by the one or more grid components is reactive power. Optionally, at least the controller function comprises a dead-band of electric power flow characteristic value such that the one or more grid components are controlled to consume power from and/or provide power to the electric power grid only when the obtained electric power flow characteristic value is outside of the dead-band.

Optionally, each grid component is configured to receive respective values of a plurality of electric power flow characteristics from a controller and consume power from and/or provide power to the electric power grid according to a respective at least one predefined function, the at least one predefined function taking the received values of the plurality of the electric power flow characteristics as an input; obtaining the measurement data comprises obtaining data indicating one or more measured values of each of a plurality of said characteristics of electric power flow in the electric power flow grid; altering the obtained electric power flow characteristic values comprises altering the obtained values of each of the plurality of the electric power flow characteristics to generate altered values of each of the plurality of the electric power flow characteristics by inputting the obtained values of each of the plurality of the electric power flow characteristics to at least one mapping function that maps the at least one predefined function onto a at least one controller function; and transmitting the altered electric power flow characteristic values comprises transmitting the altered values of the plurality of electric power flow characteristics to the one or more grid components, thereby to control the one or more grid components to consume power from and/or provide power to the electric power grid according to the at least one controller function.

According to a second aspect of the present invention, there is provided a method of providing altered electric power flow characteristic values, the method comprising, at a first entity: obtaining measurement data indicating one or more measured values of a characteristic of electric power flow in an electric power grid, wherein one or more grid components are each configured to consume electric power from and/or provide electric power to the electric power grid in accordance with a first function, based on received electric power flow characteristic values; determining a second function, different from the first function, for controlling the one or more grid components to consume electric power from and/or provide electric power to the electric power grid; altering the obtained electric power flow characteristic values to generate altered electric power flow characteristic values by inputting the obtained electric power flow characteristic values to a mapping function that maps the first function onto the second function; and outputting the altered electric power flow characteristic values.

Optionally, the method comprises: providing the altered electric power flow characteristic values to one or more components of a model of the electric power grid, thereby to simulate the behaviour of electric power flow in the grid that would result from transmitting the altered electric power flow characteristic values to the one or more grid components.

Optionally, obtaining the measurement data comprises obtaining measurement data indicating one or more measured values of each of a plurality of characteristics of electric power flow in an electric power grid, wherein one or more grid components are each configured to consume electric power from and/or provide electric power to the electric power grid in accordance with at least one first function, based on received values of the plurality of the electric power flow characteristics; determining the second function comprises determining at least one second function, different from the at least one first function, for controlling the one or more grid components to consume electric power from and/or provide electric power to the electric power grid; altering the obtained electric power flow characteristic values comprises altering the obtained values of the plurality of the electric power flow characteristics to generate altered values of the plurality of the electric power flow characteristics by inputting the obtained values of the plurality of the electric power flow characteristics to at least one mapping function that maps the at least one first function onto the at least one second function; and outputting the altered electric power flow characteristics comprises outputting the altered values of the plurality of electric power flow characteristics.

According to a third aspect of the present invention, there is provided apparatus configured to perform the method according to the first aspect or the second aspect.

According to a fourth aspect of the present invention, there is provided a computer program comprising instructions which, when executed by a computer, cause the computer to perform the method according to the first aspect or the second aspect.

According to a fifth aspect of the present invention, there is provided a system comprising: the apparatus according to the third aspect; and the one or more grid components.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a flow diagram illustrating a method according to an example;

FIG. 2 is a schematic diagram illustrating an electric power grid according to an example;

FIG. 3A is a graph illustrating a predefined function according to an example;

FIG. 3B is a graph illustrating a controller function according to an example;

FIG. 3C is a graph illustrating a mapping function according to an example;

FIG. 4 is a graph illustrating a plot of grid frequency as a function of time, according to an example;

FIG. 5 is a graph illustrating a plot of grid frequency as a function of time, an according to an example;

FIG. 6 is a schematic diagram illustrating a part of an electric power grid, according to an example;

FIG. 7 is a schematic diagram illustrating a system according to an example;

FIG. 8 is a flow diagram illustrating a method according to an example; and

FIG. 9 is a schematic diagram illustrating an apparatus according to an example.

### DETAILED DESCRIPTION

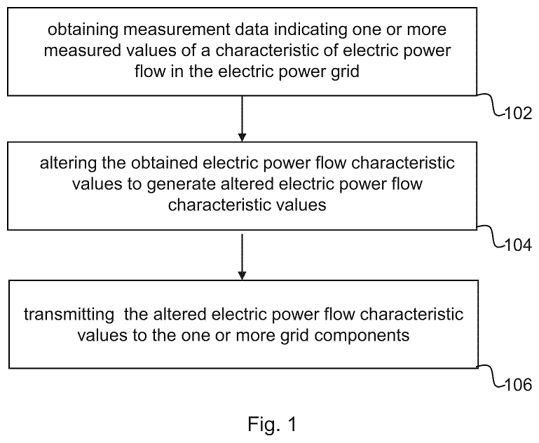

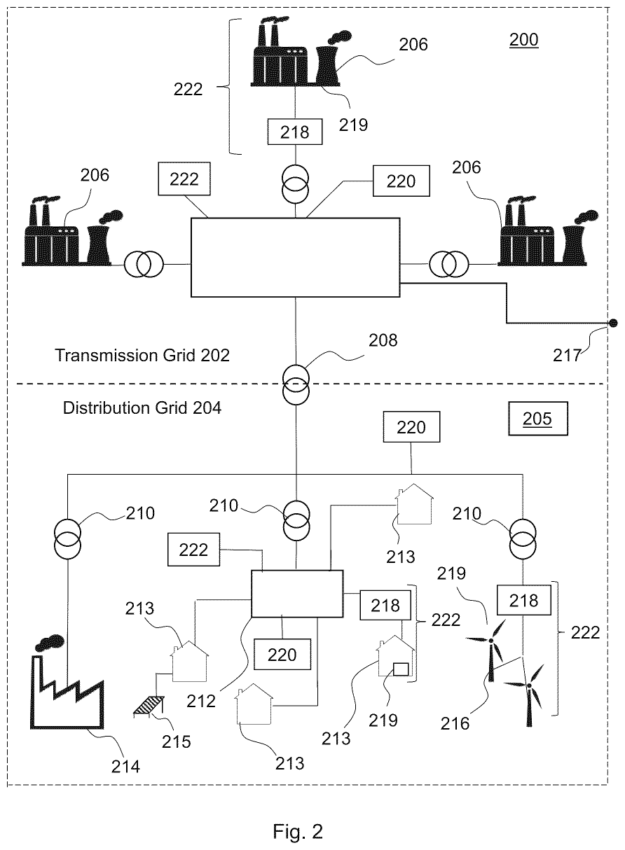

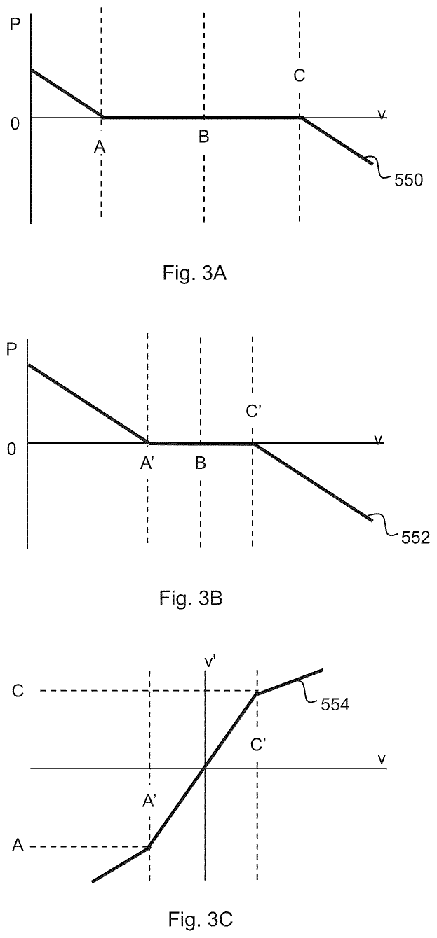

Referring to FIG. 1, there is illustrated a method of controlling one or more grid components of an electric power grid, according to an example. As described in more detail below with reference to FIGS. 2 to 3C, each grid component 222 is arranged to consume electric power from and/or provide electric power to the electric power grid 200. Moreover, each grid component 222 is configured to receive respective electric power flow characteristic values v from a controller 205 and consume power P from and/or provide power to the electric power grid 200 according to a respective predefined function 550, the predefined function 550 taking the received electric power flow characteristic values v as an input. In broad overview, the method comprises, at the controller 205:
in step 102, obtaining measurement data indicating one or more measured values v of a characteristic of electric power flow in the electric power grid 200;
in step 104, altering the obtained electric power flow characteristic values to generate altered electric power flow characteristic values v′ by inputting the obtained electric power flow characteristic values v to a mapping function 554 that maps the predefined function 550 onto a controller function 552; and
in step 106, transmitting the altered electric power flow characteristic values v′ to the one or more grid components 222, thereby to control the one or more grid components 222 to consume power P from and/or provide power to the electric power grid according to the controller function 552.

This may allow for the one or more grid components 222 to consume power from and/or provide power to the electric power grid 200 according to the controller function 552, but without having to re-program the grid components 222 with the controller function 552 (which is time consuming and resource intensive). Accordingly, this may allow for the operation of the grid components 222 according to the controller function 552 to be implemented relatively quickly and efficiently. The controller function being implemented quickly may, in turn, allow for the usefulness and/or functionality of an ancillary service provided by the one or more grid components 222 to be improved. For example, allowing for quick implementation of a controller function 552 may, in turn, allow to improve the responsiveness, of the responses provided by the grid components 220, to changes in grid conditions. An improved ancillary service may therefore be provided.

As mentioned, the method is for controlling one or more grid components 222 of an electric power grid 200. Referring now to FIG. 2, there is illustrated an electric power grid 200 according to an example.

Supply of electricity from providers such as power stations, to consumers, such as domestic households and businesses, typically takes place via an electricity distribution network or electric power grid 200. In the example of FIG. 2, the electric power grid (hereinafter ‘grid’) 200 comprises a transmission grid 202 and a distribution grid 204.

The transmission grid 202 is connected to power generators 206, which may be nuclear plants or gas-fired plants, for example, from which it transmits large quantities of electrical energy at very high voltages (typically of the order of hundreds of kV), over power lines such as overhead power lines, to the distribution grid 204.

The transmission grid 202 is linked to the distribution grid 204 via a transformer 208, which converts the electric supply to a lower voltage (typically of the order of 50 kV) for distribution in the distribution grid 204.

The distribution grid 204 is connected via substations 210 comprising further transformers for converting to still lower voltages to local networks which provide electric power to power consuming devices connected to the electric power grid 200. The local networks may include networks of domestic consumers, such as a city network 212, that supplies power to domestic appliances within private residences 213 that draw a relatively small amount of power in the order of a few kW. Private residences 213 may also use electric vehicles, battery storage, heat pumps, air conditioning devices and photovoltaic devices 215 to provide relatively small amounts of power for consumption either by appliances at the residence or for provision of power to the grid. The local networks may also include industrial premises such as a factory 214, in which larger appliances operating in the industrial premises draw larger amounts of power in the order of several kW to MW. The local networks may also include networks of smaller power generators such as battery storage, solar and wind farms 216 that provide power to the electric power grid.

Although, for conciseness, only one transmission grid 202 and one distribution grid 204 are shown in FIG. 2, in practice a typical transmission grid 202 supplies power to multiple distribution grids 204 and one transmission grid 202 may also be interconnected to one or more other transmission grids 202.

Electric power flows in the electric power grid 200 as alternating current (AC), which flows at a system frequency, which may be referred to as a grid frequency (typically 50 or 60 Hz, depending on country). The electric power grid 200 operates at a synchronized frequency so that the frequency is substantially the same at each point of the grid.

The grid 200 may include one or more direct current (DC) interconnects 217 that provide a DC connection between the electric power grid 200 and other electric power grids. Typically, the DC interconnects 217 connect to the typically high voltage transmission grid 202 of the electrical power grid 200. The DC interconnects 217 provide a DC link between the various electric power grids, such that the electric power grid 200 defines an area which operates at a given, synchronised, grid frequency that is not affected by changes in the grid frequency of other electric power grids. For example, the UK transmission grid is connected to the Synchronous Grid of Continental Europe via DC interconnects.

The electric power grid 200 may comprise one or more measurement devices 220 for measuring a value v of a characteristic of electric power flow in the electric power grid 200. For example, the measurement device 220 may comprise a phasor measurement unit (PMU), which may be configured to measure one or more of a frequency, voltage, current, power, reactive power, and phase angle of electricity flowing in the electric power grid. As another example, the measurement device 220 may comprise other types of measurement devices such as a Power Meter or a Digital Fault Recorder (DFR). A DFR may be configured to sample and record electric power flow characteristic values including but not limited to harmonics, frequency, and voltage levels of electricity flowing in the electric power grid. For example, a DFR may sample data captured by, for example, protection relays of the grid. As another example, the one or more measurement devices 220 may comprise a measurement device configured to measure electric power flow characteristic values for power lines, such EMF (electromagnetic forces) and dynamic line rating measurement devices such as thermal, vibration, current sensors and radar and/or optical sensors. For example, a thermal sensor may measure the temperature of a power line, which may be indicative of the current flowing in the power line. As another example, optical sensors may measure current and/or voltage of electrical energy flowing in a power line, for example making use of the Pockels effect. Other measurement devices may be used, such as measurement devices configured to measure a synchrophasor and/or a Point on Wave of electricity flowing in the electric power grid. Other measurement devices may be used.

The grid 200 comprises one or more grid components 222.

The grid components 22 may, for example, form part of an ancillary service (e.g. a dynamic containment ancillary service) to the electric power grid 200, to support the stability of electric power flow in the grid, for example to assist in keeping electric power flow characteristic values within specified limits. For example, in peak times of electrical power consumption, or for example where a generator 206 develops a fault, the amount of power consumed may be larger than the amount of power generated. In this case, the grid frequency may begin to fall. In such a case, grid components 220 of a frequency ancillary service may be triggered to provide power to the grid 200, in order to assist in returning the grid frequency to its nominal value, for example.

In any case, each grid component 222 is arranged to consume electric power from and/or provide electric power to the electric power grid 200. Moreover, each grid component 222 is configured to receive respective electric power flow characteristic values from a controller 205 and consume power from and/or provide power to the electric power grid 200 according to a respective predefined function 550, the predefined function 550 taking the received electric power flow characteristic values as an input (described in more detail below with reference to FIG. 3A).

In some examples, the electric power flow characteristic may be indicative of, including but not limited to, one or more of inertia, a short circuit ratio, a fault level, and/or a system strength of the electric power grid; and/or a frequency, a voltage, a current, a reactive power, one or more oscillations, one or more harmonics, and/or a phase angle, of electricity flowing in the electric power grid.

For example, the electric power flow characteristic may be indicative of a frequency of electricity flowing in the electric power grid 200. For example, electric power flow characteristic may be the frequency of electricity flowing in the electric power grid 200, or a deviation of the frequency from a nominal value such as 50 Hz. In this case, the predefined function may, for example, comprise a trigger value of grid frequency (or deviation) below which the grid component 222 provides power to the grid 200, and as such causes the grid frequency to return towards its nominal value.

In some examples, the electric power flow characteristic may be indicative of one or more of a voltage, current, phase angle, and reactive power of electricity flowing in the electric power grid. The phase angle o may describe the phase shift that exists between voltage and current. Reactive power may be given by the product of voltage, current, and sin(φ). For example, the electric power flow characteristic may be a voltage (or reactive power, or phase angle) of electricity flowing in the grid 200 (or a part thereof, such as the distribution grid 204). In this case, the predefined function may, for example, comprise a trigger value of voltage (or reactive power, or phase angle) below which the grid component provides reactive power to the grid 200 (or a part thereof), and as such causes the voltage (or reactive power or phase angle) to return towards its nominal value.

In some examples, the electric power flow characteristic may be indicative of inertia of electricity flowing in the electric power grid. Grid inertia is a measure of the amount of kinetic energy stored in the electric power grid and influences the rate at which the operating frequency of the grid changes in response to a change in balance of power provision and consumption in the grid. As an example, a spinning generator having a spinning turbine with relatively large mass may store relatively large amounts of kinetic energy and hence provide relatively large inertia. In this case, the predefined function may, for example, comprise a trigger value of inertia below which a grid component able to provide relatively large inertia is made operational and hence increases the inertia of the grid or a particular portion of the grid to a nominal or desired value. As another example, each of a group of relatively small generators may have a predefined function which, for example, may comprise a trigger value of inertia below which each generator is configured to provide electric power to the electric power grid in a synchronised fashion. The inertia provided by each individual small generator may not itself be particularly large, but the group of small generators synchronising the electric power provision and inertia provided to the electric power grid may increase the inertia of the grid or a particular portion of the grid to a nominal or desired value.

In some examples, the electric power flow characteristic may be indicative of one or more oscillations of electricity flowing in the electric power grid 200. For example, there may be one or more oscillations in the grid frequency. For example, oscillations in grid frequency may occur between different areas of the electric power grid 200, or for example, as a result of over-correction by other ancillary service units. For example, the electric power flow characteristic value may be an amplitude of the oscillation. A grid component 222 may provide an associated oscillation in power provided to or consumed from the grid 200 so as to dampen the frequency oscillation. In this case, the predefined function may, for example, comprise a trigger value of oscillation amplitude above which the grid component provides an oscillation in power consumed from or provided to the grid 200 so as to dampen the frequency oscillation, and as such cause a reduction in the amplitude of the frequency oscillation.

In some examples, the electric power flow characteristic may be indicative of one or more harmonics of electricity flowing in the electric power grid 200. For example, there may be one or more harmonics to the fundamental grid frequency. A grid component 222 may consume power from and/or provide power to the electric power grid in a way that reduces harmonics in the grid 200. As one example, a grid component 222 may comprise a harmonic filter, which may consume electric power by routing unwanted harmonic currents to ground. For example, a harmonic filter may comprise a resonant circuit in series or parallel with the grid and may route harmonic currents to ground. In this case, the predefined function may comprise, for example, a set or trigger value of harmonic amplitude above which the grid component 222 activates a harmonic filter, thereby consuming electric power by routing the harmonic currents to ground, thereby reducing the amplitude of the harmonics in the grid 200. As another example, harmonics can be controlled by controlling the dispatch of power providing grid components 222 (e.g. generators) in a given area of the grid 200. For example, the dispatch of grid components 222 may represent the electric power provided by each power providing grid component 222 to the grid 200 at a given time. By controlling different grid components 222 located at different positions within the grid to provide certain different amounts of electric power to the grid 200, harmonics in the grid can be reduced. In this case, the predefined function at each given grid component 222 may comprise, for example, a set or tigger value of harmonic amplitude above which the grid component 222 reduces (or increases) its power provision so as match the certain amount, which may accordingly reduce the amplitude of the harmonics in the grid 200 (or a certain area of the grid).

In some examples, the electric power flow characteristic may be indicative of a short circuit ratio, a fault level, and/or a system strength of the electric power grid. A fault level at a given location in the grid is proportional to the fault current (that is, the current that flows during a fault) and the voltage. The system strength at a given location is indicative of the size of a change in voltage following a fault and is proportional to the fault level. The short circuit ratio may be taken as the fault level divided by the rated output of a generator measured at the generator's connection point. For example, a grid component 222 may provide reactive power to support voltage in weak areas of the grid (that is, areas with low system strength). In this case, the predefined function may, for example, comprise a trigger value of system strength below which the grid component provides reactive power to the grid to support the voltage, and as such causes an increase in the system strength.

As such, the one or more grid components 222 may provide an ancillary service to the electric power grid 200.

In some examples, a grid component 222 may be provided by a device that consumes/provides electric power from/to the grid according to the predefined function 550. For example, the grid component 222 may take the form of a grid battery or a domestic battery 222. For example, a grid battery 222 connected to the grid may consume power from and/or provide power to the electric power grid 200 (e.g. by charging and discharging, respectively) according to the predefined function 550. In some examples, providing an ancillary service to the grid 200 may be the sole or primary function of the grid component 222.

In some examples, a grid component 222 may comprise a modulation device 218 and an associated one or more power units 219. For example, each power unit 219 may be configured to consume electric power from and/or provide electric power to the electric power grid 200, and an associated modulation device 218 may be configured to modulate (e.g. reduce or increase) the consumption and/or the provision so that the one or more power units 219 consume power from and/or provide power to the electric power grid 200 according to the predefined function. For example, the one or more power units 219 may be connected to the grid 200 via the modulation device 218. For example, a wind farm 216 may comprise multiple turbines 219, and a modulation device 218 may modulate the total power output by the windfarm to the grid 200. As another example, a household 213 may comprise multiple appliances 219, and a modulation device 218 may modulate the total power consumed by the household. For example, this may be provided as a service operated by a utility company or other party. As such, in some examples, the grid component 222 or parts thereof may have other purposes than providing an ancillary service to the grid 220, but may, when required, be able to contribute to providing an ancillary service to the grid.

As mentioned, the method of FIG. 1 comprises, in step 102, obtaining measurement data indicating one or more measured values v of a characteristic of electric power flow in the electric power grid 200. For example, the measurement data may be obtained from, or derived from the output of, one or more of the measurement devices 220. For example, a phaser measurement unit may measure a frequency, a voltage, a reactive power, a phase angle, one or more oscillations and one or more harmonics of electricity flowing in the electric power grid, and these measurements (e.g. the voltage, current etc.) may be used to derive a short circuit ratio, a fault level, and/or a system strength of the electric power grid, for example as described above.

In some examples, obtaining the measurement data may comprise, at the controller 205: obtaining a plurality of measurements of electric power flow characteristic values taken at a respective plurality of different locations in the electric power grid; and combining the plurality of measurements to determine the obtained electric power flow characteristic values. Combining the plurality of measurements may allow for a more accurate and/or reliable measurement of electric power flow characteristic value, for example as compared to using one value. For example, if one of the values happens to be erroneous, this will be mitigated by the combination with other values. Alternatively or additionally, combining the plurality of measurements may allow for a faster determination of the electric power flow characteristic value. For example, some electric power flow characteristic values, such as frequency, may be determined from multiple samples taken during a sampling window, for example to provide a value of the electric power flow characteristic value within a certain level of statistical confidence. However, combining the plurality of measurement values taken at different locations may provide the certain level of statistical confidence in the value and hence reduce the length of the sampling window used to produce the value. In turn, the value may be determined more quickly, that is, with a lower latency. This may help improve the responsiveness of grid components to the value. Alternatively or additionally, combining the plurality of measurement values may allow for an electric power flow characteristic value representative of an area of, or the whole of, the electric power grid to be determined. This may, in turn, allow for grid components to be provided with area specific or national or synchronous regional electric power flow characteristic values. This may, in turn, allow for improved granularity with which the grid components may be controlled. In any case, measurement data indicating one or more measured values of a characteristic of electric power flow in the electric power grid 200 are obtained.

As mentioned, the method of FIG. 1 then comprises, in step 104, altering the obtained electric power flow characteristic values to generate altered electric power flow characteristic values by inputting the obtained electric power flow characteristic values to a mapping function that maps the predefined function onto a controller function.

Referring to FIG. 3A to 3C, there are illustrated a predefined function 550 (FIG. 3A), a controller function 552 (FIG. 3B), and a mapping function 554 (FIG. 3C) according to an example.

Referring to FIG. 3A, there is illustrated an example of a predefined function 550. As can be seen, in this example, the predefined function 550 defines the power P that the grid component 222 is to provide power to or consume power from the electric power grid 200 as a function of electrical power flow characteristic value v. In this example, positive values of power P correspond to providing power to the grid 200 and negative values of power P correspond to consuming electrical power from the grid 200. The value B may correspond to a nominal value of the electrical power flow characteristic value v. At this value, the power P is zero. This may correspond to the grid component 220 neither providing power to nor consuming power from the grid 220 (or for example, neither increasing nor decreasing a present state of power consumption or provision of a power unit 119 of the grid component 220). The predefined function 550 has dead-band centred around the value B and extending from a lower trigger value A to a higher trigger value C of electrical power flow characteristic value v. That is, in the range of electrical power flow characteristic value v from the lower trigger value A to the higher trigger value C, the power P is zero. For values of electric power flow characteristic value v above the higher trigger value C, the power P decreases linearly with electric power flow characteristic value v. For values of electric power flow characteristic value v below the lower trigger value A, the power P increases linearly with electric power flow characteristic value. For example, where the electric power flow characteristic value v is grid frequency, the nominal value B may be 50 Hz, the dead-band may be +/−0.03 Hz, and as such the higher trigger value C may be 50.03 Hz, and the lower trigger value A may be 49.97 Hz. In some examples, the power P may be in the form of a percentage of the maximum power that the grid component 222 can consume and/or provide.

However, it may be desired that the grid component 222 implements instead the controller function 552 shown in FIG. 3B. For example, it may be determined that the ability of the grid 200 to withstand faster occurring changes in grid frequency would be improved by reducing the dead-band. Accordingly, in this example, the controller function 552 is similar to the predefined function 550, except that the size of the dead-band has been reduced. Specifically, the controller function 552 has a dead-band centred around the same value B as for the predefined function, but the dead-band of the controller function 552 instead extends from a lower trigger value A′ (which is higher than the lower trigger value A of the predefined function 550) to a higher trigger value C′ (which is lower than the higher trigger value C of the predefined function 550) of electrical power flow characteristic value v. In the controller function 552, for values of electric power flow characteristic value v above the higher trigger value C′, the power P decreases linearly with increasing electric power flow characteristic value v, and for values of electric power flow characteristic value v below the lower trigger value A′, the power P increases linearly with decreasing electric power flow characteristic value. For example, where the electric power flow characteristic value v is grid frequency, the nominal value B may be 50 Hz, the dead-band may be +/−0.015 Hz, and as such the higher trigger value C′ may be 50.015 Hz, and the lower trigger value A may be 49.985 Hz.

Referring to FIG. 3C, there is illustrated a mapping function 554 that maps the predefined function 550 onto the controller function 552. Specifically, the mapping function 554, for a given input measured electric power flow characteristic value v, outputs an altered electric power flow characteristic value v′. Specifically, for a given measured electric power flow characteristic value v, the altered electric power flow characteristic value v′ is that which when input into the predefined function 550 results in the predefined function 550 outputting a power P that the controller function 552 outputs for the given measured electric power flow characteristic value v. As an example, as can be seen in FIG. 3C, the mapping function maps the trigger points A′ and C′ onto the trigger points A and C respectively. As such, when the measured electric power flow characteristic value v is at the trigger point C′ (or A′), the altered electric power flow characteristic value v′ is at the trigger point C (or A, respectively).

As mentioned, the method of FIG. 1 comprises, in step 106, transmitting the altered electric power flow characteristic values v′ to the one or more grid components 222, thereby to control the one or more grid components 222 to consume power from and/or provide power to the electric power grid 200 according to the controller function 552. As an example, for a measured electric power flow characteristic value v having a value of C′, the altered electric power flow characteristic value v′ output by the mapping function 554 may have a value of C. This altered electric power flow characteristic value of C may be transmitted to the grid component 222, which may then, for example in a manner as described above, input this into the predefined function 550 and accordingly determine that the trigger value C has been met and hence the grid component 222 should start to consume power P from the grid 200. As another example, similarly, for a measured electric power flow characteristic value v having a value of A′, the altered electric power flow characteristic value v′ output by the mapping function 554 may have a value of A. This altered electric power flow characteristic value of A may be transmitted to the grid component 222, which may then, for example in a manner as described above, input this into the predefined function 550 and accordingly determine that the trigger value A has been met and hence the grid component 222 should start to provide power P to the grid 200. Accordingly, the grid component 222 is controlled to consume power from and/or provide power to the electric power grid 200 according to the controller function 552, but without having to necessarily change or reprogram the predefined function 550 at the grid component 220.

As described above, in some examples, the predefined function 550 may define a first trigger point (A or C) of the electric power flow characteristic value v at which the respective grid component 222 is triggered to consume power from or provide power to the electric power grid 200. The controller function 552 may define a second trigger point (A′ or C′) of the electric power flow characteristic value v different to the first trigger point (A or C). Transmitting the altered electric power flow characteristic values v′ to the one or more grid components 222 may trigger the one or more grid components 222 to consume power from and/or provide power to the electric power grid when the obtained electric power flow characteristic value v is at the second trigger point (A′ or C′). For example, the first trigger point (A or C) may be +/−0.03 Hz deviation from the nominal grid frequency B, and the second (e.g. the desired) trigger point (A′ or C′) may be +/−0.015 Hz deviation. In this case the mapping function may be simply “multiply the measured frequency deviation by 2”, or expressed in terms of an equation, v′=2(v).

In some examples, the controller function 552 and/or the mapping function 554 may be relatively simple, for example as per the example described above. In some examples, the controller function 552 and/or the mapping function 554 may be arbitrarily complex, and may for example involve linear and non-linear functions. In general, in some examples the mapping function may take the form v′=F(v), where F is any function that maps the predefined function 550 to a desired controller function 552.

In some examples, the controller function 552 may be constructed according to a service specification of a grid operator, for example a dynamic containment service specification. For example, the electric power flow characteristic value may be a grid frequency deviation from the nominal frequency, the controller function 552 may be constructed so as to have a dead-band (i.e. provide/consume 0% of the grid components power provision/consumption capacity) in the range +/−0.015 Hz; a first linear increase of power consumed by the grid component 222 from 0% to a maximum of 5% of the grid components consumption capacity between +0.015 Hz and +0.2 Hz; a corresponding first linear increase of power provided by the grid component 222 from 0% to a maximum of 5% of the grid components 222 provision capacity between −0.015 Hz and −0.2 Hz; a second increase (e.g. linear increase) of power consumed by the grid component 222 from 5% to 100% of the grid components 222 consumption capacity between +0.02 Hz and +0.5 Hz; and a corresponding second increase (e.g. linear increase) of power provided by the grid component 222 from 5% to a 100% of the grid components 222 provision capacity between −0.02 Hz and −0.5 Hz. Other controller functions may be used, for example as and when different service specifications are issued.

As mentioned above, in some examples, it may be desired to implement the controller function 552 instead of the predefined function 550, for example as a result of a change in policy of the grid operator. However, in some examples, the alteration of the obtained electric power flow characteristic values may be responsive to other events.

For example, in some examples, altering the obtained electric power flow characteristic values may be responsive to a detected and/or forecasted change in a grid condition of the electric power grid. This may allow for the response that grid components 222 provide to be changed either during or before a change in a grid condition such as a frequency event or a drop in inertia. For example, an event nadir may be forecast, and a grid component's 222 response may triggered by the altered grid characteristic value before the nadir occurs. The change in grid condition may be detected or forecasted by the controller 250 or another entity.

In some examples, the grid condition may comprise one or more of inertia, a short circuit ratio, a fault level and/or a system strength of the electric power grid; and/or a frequency, a voltage, a current, a reactive power, one or more oscillations, one or more harmonics, and/or a phase angle of electricity flowing in the electric power grid. Grid inertia is a measure of the amount of kinetic energy stored in the electric power grid and influences the rate at which the operating frequency of the grid changes in response to a change in balance of power provision and consumption in the grid. A change in any one or more of these grid conditions may mean that one or more controller functions would be more optimal for responding to changes in electric power flow characteristic values than the predefined function. As an example, when a change in grid inertia is detected, a controller function in which the dead-band is reduced and/or is more aggressive as compared to that of a predefined function may be more preferable, in order to provide a faster response to a change in power balance in the grid.

For example, referring to FIG. 4, there is a plot illustrating a change in grid condition of the electric power grid 200, according to an example. Specifically, in this example, the plot is of grid frequency f against time t. Between times t₁ and t₂, the grid frequency is at its nominal value f₀. However, at time t₂, the grid frequency begins to drop rapidly, before levelling out to a new value at time t₄ (the event nadir). For example, such an event may be caused by a generator 206 ceasing to operate due to a fault. The change in grid condition (in this case, the drop in grid frequency to the value at time t₄) may be detected by detecting the drop in frequency between times t₂ and t₄. In some examples, the change in grid condition may be forecast by analysing the drop in frequency between times t₂ and t₃, and forecasting or predicting that the frequency will continue to drop to its value at t₄. For example, the forecasting may be achieved by fitting a polynomial function to the frequency as a function of time, and extrapolating the function to future times. For example, the alteration of the electric power flow characteristic values may be triggered in response to a prediction at time t₃ that the frequency will continue to fall, and hence the grid components may provide power to the grid 200 (and hence assist in returning the grid frequency to its nominal value) earlier than would have otherwise been the case. A more effective response to changes in grid condition may therefore be provided.

In some examples, the method may comprise dynamically varying the alteration of the obtained electric power flow characteristic values v in response to one or more detected or forecasted changes in a grid condition of the electric power grid. This may allow for the altered response that the grid components 222 provide to vary according to developing conditions in the grid. This may provide for a more tailored response to an electric power flow characteristic value event. The detected or forecasted changes in grid condition may, for example, be the same as those mentioned above. Dynamically varying the alteration may comprise, for example: at a first time, altering the obtained electric power flow characteristic values v to generate first altered electric power flow characteristic values by inputting the obtained electric power flow characteristic values to a first mapping function that maps the predefined function onto a first controller function; and at a second later time (e.g. responsive to one or more detected or forecasted changed in grid condition) altering the obtained electric power flow characteristic values v to generate second altered electric power flow characteristic values by inputting the obtained electric power flow characteristic values to a second mapping function that maps the predefined function onto a second controller function. For example, the second controller function may have a smaller dead-band and/or increased gradient of power P as a function of electric power flow characteristic value v outside the dead-band, as compared to the first controller function. In any case, dynamically varying the alteration may allow for a more granular and/or tailored response to changes in grid condition to be provided.

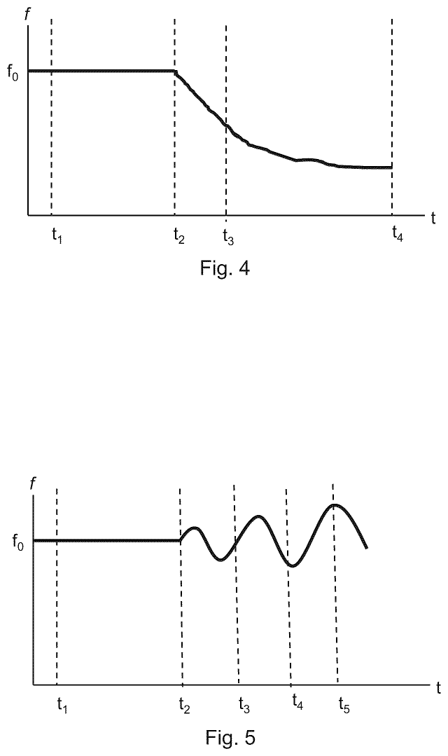

As mentioned, in some examples, the grid condition may comprise one or more oscillations of electricity flowing in the electric power grid. For example, the one or more oscillations may be inter-area oscillations, such as oscillations in power or frequency between different areas of the grid 200. As another example, the one or more oscillations may result from one or more ancillary service units becoming fixed in a feedback loop, whereby rather than counteract deviations of, for example frequency from the nominal value, as they were designed to do, the one or more ancillary service units may end up contributing to the deviations, in the form of such oscillations. For example, the oscillations may occur at frequencies on the order of 1 Hz or a few Hz or 0.5 Hz, for example. Referring to FIG. 5, there is illustrated a plot of grid frequency f against time t. Between times t₁ and t₂, the grid frequency f is at its nominal value f₀. However, at time t2, the grid frequency begins to oscillate. Between times t₂ and t₃, the period, frequency and/or phase of the oscillation may be determined, for example.

In some examples, dynamically varying the alteration may comprise varying the alteration so as to dampen one or more of the oscillations. This may help to damp or eliminate oscillations in e.g. grid frequency that may develop between different parts of the grid or which may occur as a result of responsive ancillary service units becoming locked in a feedback loop. For example, dynamically varying the alteration may comprise varying the altered electric power flow characteristic values so that the one or more grid components 222 vary the power provided to or consumed from the grid 200 out of phase with the oscillations. For example, at time t₄, the oscillation in grid frequency is at a trough (that is, a minimum value), and hence the electric power flow characteristic value may be altered so as to cause one or more grid components 222 to provide power to the grid at this time. However, at time t₅, the oscillation in grid frequency is at a peak (that is, a maximum value), and hence the electric power flow characteristic value may be altered so as to cause the one or more grid components 222 to consume power from the grid at this time. As such, the oscillations may be dampened.

In some examples, the dynamic variation may take into account a latency or delay between transmitting the altered electric power flow characteristic value and the one or more grid components 222 providing and/or consuming power in response. For example, if a measured oscillation of electric power flow characteristic value has a period of 1 s, and the time taken from transmitting the altered electric power flow characteristic value to the grid component providing or consuming power to the grid 200 according to the received value is 0.5 s, then dynamically varying the alteration of the electric power flow characteristic value may comprise oscillating the altered electric power flow characteristic value with a phase shift of 0.5 s as compared to the measured oscillation, thereby to ensure that the controlled power consumption/provision is indeed out of phase with the oscillation and hence damps the measured oscillation.

In some examples, altering the obtained electric power flow characteristic values (or indeed dynamically varying the alteration) may be responsive to one or more time points in a time schedule being reached. This may allow for the function according to which the grid components are controlled to consume/provide power to be dependent on a time, e.g. a time of day or a time of year. This may provide a simple way to account for differences in grid conditions that may occur at those different times. For example, power consumption may be known to peak at certain times of day and/or at certain times of year. Accordingly, the controller function according to which the grid components consume/provide power to the grid may be different for those different times. For example, at peak times of consumption, the dead-band may be reduced.

In some examples, only the altered electric power flow characteristic values are transmitted from the controller 205 to the one or more grid components 222. However, in some examples, one or more further signals may be transmitted in addition to the altered electric power flow characteristic values.

In some examples, the predefined function 550 at each of the one or more grid components 222 is fixed. For example, the predefined function, or parameters (such as trigger values) characterising of the pre-defined function 550 stored at the grid component 222, may not be changeable. In some examples the predefined function at the grid component 222 may only be changed by manually re-programming the grid component 222 with a new predefined function. For example, on manufacture or installation of a grid component 222, the predefined function 550 may be pre-programmed into a memory of the grid component 222, and the predefined function 550 may not be changed or changeable, or for example may only be changed by manual re-programming of the grid component 222. In these cases, altering the electric power flow characteristic values and transmitting them to the one or more grid components 222 in the manner described above may allow for the grid components to consume/provide power according to a different function (that is, the controller function 552), and/or allow for the grid components to consume/provide power according to the controller function but without having to manually re-program the grid component 222 with the controller function 552 to replace the predefined function 550 (and without having to re-test the grid component 222 for compliance with the specifications of the re-programmed function). As described, this may allow for improved flexibility and/or cost effectiveness of providing a response to changes in electric power flow characteristics value.

However, in some examples, the predefined function stored at each grid component 222 may not necessarily be fixed and may in some examples include one or more parameters that can be varied. In such examples, the method may comprise transmitting, to the one or more grid components 222, in addition to the altered electric power flow characteristic values, a reparameterization signal configured to cause each of the one or more grid components 222 to change one or more parameters of the predefined function 550 according to which the grid component 222 is configured to consume power from and/or provide power to the electric power grid 200. This may allow, in addition to the control of the power consumption/provision of a grid component 222 provided by altering the electric power flow characteristic values, control of the power consumption/provision of a grid component 222 by causing the grid component 222 to change one or more parameters of the predefined function 550 itself.

In some examples, it may be useful to, in addition to altering the electric power flow characteristic values, change certain parameters of the predefined function via the reparameterization signal, as in some cases it may not be possible to control certain parameters via the altered electric power flow characteristic alone. For example, the one or more parameters may define an aggressiveness of the response, for example the amount of power P, or percentage of total available power, that a grid component 222 is to provide to and/or consume from the grid 200. For example, the signal may increase or decrease the maximum power (or the maximum percentage of total available power) consumption/provision included in the predefined function 550. It may be useful to alter the maximum power consumption/provision that the predefined function specifies using the reparameterization signal, as in some cases this may not be achieved by altering the electric power flow characteristic values alone. As another example, the one or more parameters may define a mode of the consumption/provision of power by the grid component 222, for example specifying the phase angle and hence the proportion of reactive power the grid component 222 is to provide/consume. Again, it may be useful to alter the mode of power consumption/provision using the reparameterization signal, as in some cases this may not be achieved by altering the electric power flow characteristic values alone. Accordingly, in these cases, a more tailored and/or granular response to changes in electric power flow characteristic values may be provided, for example as compared to using the altered electric power flow characteristic values alone.

In still further examples, certain other parameters of the predefined function 550 may be changed using the reparameterization signal. For example, the one or more parameters may be one or more trigger points of the predefined function 550. For example, the reparameterization signal may reparametrize the predefined function so as to have a smaller or larger dead-band, for example. In some cases, it may be useful to, in addition to controlling such parameters via the altered electric power flow characteristics, also change such parameters via the reparameterization signal. As one example, it may be desired to control a plurality of grid components 222 according to a given controller function 552 (e.g. so that they can provide a coordinated response to changes in electric power flow characteristic value), but each of the plurality of grid components 222 may have a different predefined function 550. In this case, the grid components 222 could be controlled using a respective plurality of mapping functions 554, and transmitting a respective plurality of altered electric power flow characteristic value streams to the respective grid components 222. However, it may be desirable to limit the number of different altered electric power flow characteristic value streams that are transmitted, for example in order to reduce communications overhead and hence improve communication efficiency. In this case, a reparameterization signal may be initially transmitted to one or more of the grid components 222 so that the predefined function 550 is (and in some examples only temporarily) homogenised (for example, the same) at two or more of the grid components 222. These two or more grid components 222 may therefore be controlled according to the controller function 552 based on the same altered electric power flow characteristic values. This may reduce the number of different altered electric power flow characteristic values streams that need to be transmitted, and hence improve communication efficiency. As another example, a reparameterization signal may be used to reparametrize the predefined function in advance, for example before a change in grid condition (e.g. a frequency event) has occurred, and the alteration of the electric power flow characteristics may be used to further control the grid component 222 to consume/provide power according to the controller function in response to a change in grid condition (e.g. the frequency event occurring). This may allow effective responses to be provided to dynamic changes in grid condition. As yet another example, the reparameterization signal may be used to reparametrize one parameter of the predefined function, and the alteration of the electric power flow characteristic values may be used to effect control of another parameter. For example, the amount of power that the grid component 222 consumes and/or provides according to the predefined function may be changed via the reparameterization signal, whereas the speed at which the power consumption/provision is provided (e.g. how narrow the dead-band is, how steep the gradient of the power consumption/provision as function of electric power flow characteristic value is, or the general functional form of the power consumption/provision as function of electric power flow characteristic value) may be controlled via the alteration of the electric power flow characteristic values. The latter may be particularly time consuming and resource intensive to change by manual re-programming, and hence controlling these parameters via the alteration of the electric power flow characteristic values may provide for particular improvements in speed and efficiency of implementing control according to a controller function.

In some examples, each grid component 222 may have (e.g. store) only one predefined function 550. However, in other examples, each of the one or more grid components 222 may have a plurality of selectable predefined functions according to which the respective grid component 222 is configurable to consume power from and/or provide power to the electric power grid 220.

For example, the plurality of predefined functions may differ from one another in any one or more of a number of different ways. For example, as above, each predefined function may be parametrised by one or more parameters, and the predefined functions may differ from one another in that one or more of the parameters differ between predefined functions. For example, as also described above, the one or more parameters may include one or more of an aggressiveness of the predefined function, a gradient of one or more parts of the predefined function, one or more trigger points of the predefined function, a mode of the consumption/provision of power by the grid component 222 and/or a delay that is to be applied by the grid component before power is provided/consumed by the grid component 222.

In these cases, the method may comprise transmitting to the one or more grid components 222, in addition to the altered electric power flow characteristic values, a selection signal configured to cause each of the one or more grid components 222 to select, respectively, a predefined function of the plurality of predefined functions, whereby the respective grid component is configured to consume power from and/or provide power to the electric power grid according to the selected predefined function. For example, a given grid component 222 may be operating according to a first predefined function of the plurality of selectable predefined functions. The grid component 222 receives the selection signal which specifies that the grid component 222 is to operate according to a second predefined function of the plurality of selectable predefined functions. The grid component, on receipt of this selection signal, retrieve and operate according to the second predefined function. As an example, where low inertia is detected, measured or forecast in the electric power grid, the selection signal be configured to cause one or more of the grid components 222 to each select a predefined function that provides a more aggressive response to changes in grid frequency. Other criteria may be used. This may allow, in addition tailoring the response that the grid components 222 provide by altering the electric power flow characteristics, to tailor the response by causing the grid component to select a specific one of a plurality of predefined functions.

In some examples, the methods described above may be applied to only one grid component 222. However, in other examples, the methods may be applied to a plurality of grid components 222. This may allow for multiple grid components 222 to provide a coordinated response to changes in electric power flow characteristic value. This may allow for a larger and hence more effective response to changes in electric power flow characteristic value to be provided.

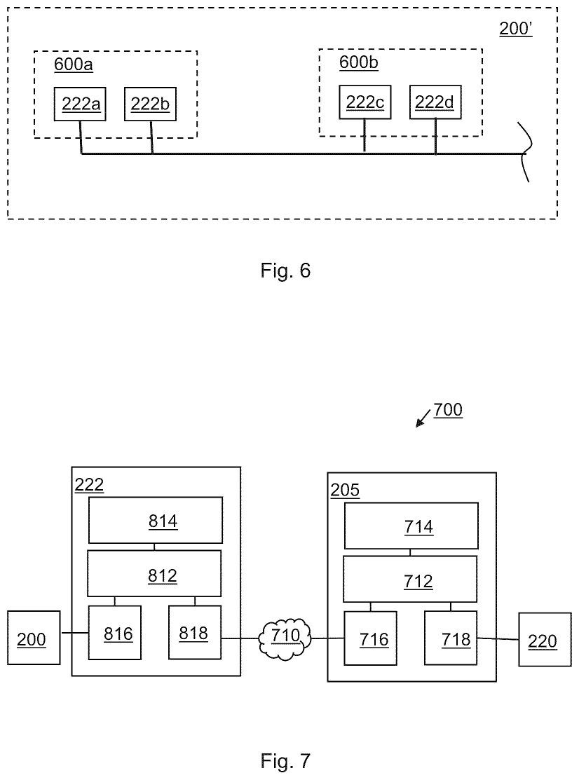

Referring to FIG. 6, there is illustrated a portion of an electric power grid 200′. For clarity, FIG. 6 only shows grid components 222, but it will be appreciated that the electric power grid 200′ shown in FIG. 6 may, for example, be the same or similar to the electric power grid 200 described above with reference to FIG. 2. In the example of FIG. 6, the grid 200′ comprises a plurality of (in this example four) grid components 222a, 222b, 222c, 222d.

In some examples, the method may comprise selecting a first group 600a of one or more 222a, 222b of the plurality of grid components 222a-222d; and transmitting the altered electric power flow characteristic values to each grid component 222a, 222b of the selected first group 600a. This may allow to provide increased granularity in the response to changes in electric power flow characteristic value provided by the grid components 222. For example, as described in more detail below, the grid components 222 may be selected to be in the first group based on an area in which the grid components are located, a type of the grid component 222, and/or a current operational status of the grid component 222.

In some examples, the grid components 222 of the first group 600a may all have the same predefined function 550. In this case the same altered electric power flow characteristic values may be transmitted to each grid component 222a, 222b of the selected first group 600a. In this case, transmitting the altered electric power flow characteristic values may comprise broadcasting the altered electric power flow characteristic values to the first group 600a. For example, where the grid components 222 of the first group 600a are all in the same area, the altered electric power flow characteristic values may be broadcast to that area. In that case, all of the grid components 222 in that area may be controlled to consume/provide power according to the controller function 552. However, in some examples, one or more of the grid components of the first group 600a may have a predefined function 550 that is different to the predefined function 550 of one or more other grid components of the first group 600a. In this case, in order to control each of the grid components of the first group 600a according to the same controller function 552, different altered electric power flow characteristic values may be transmitted to different grid components 222 in the first group 600a (according to the respective different mapping functions 554 that map the respective different predefined functions 550 onto the controller function 552). In this case, for example, transmitting the altered electric power flow characteristic values may comprise transmitting to each grid component 222 of the first group 600a individually. In some examples, the method may comprise selecting a second group 600b of one or more 222c, 222d of the plurality of grid components 222. In these examples, the method may comprise transmitting second altered electric power flow characteristic values to each grid component 222c, 222d of the second group 600b of grid components. For example, the second altered electric power flow characteristic values may be different from first altered electric power flow characteristic values transmitted to the first group 600a. For example, the first altered electric power flow characteristic values may be obtained by inputting the obtained electric power flow characteristic values to a first mapping function 554 that maps the predefined function 550 onto a first controller function 552, thereby to control the first group 600a of grid components 222a, 222b to consume power from and/or provide power to the electric power grid 200′ according to the first controller function 552. Whereas, for example, the second altered electric power flow characteristic values may be obtained by inputting the obtained electric power flow characteristic values to a second mapping function (not shown) that maps the predefined function 550 onto a second controller function (not shown), different from the first controller function 552, thereby to control the second group 600b of grid components 222c, 222d to consume power from and/or provide power to the electric power grid according to the second controller function (not shown). This may allow for different groups of the grid components 222 to operate according to different controller functions 552. This may allow to further improve the granularity with which a response to a change in electric power flow characteristic value can be provided. As also described above for the first group 600a, the grid components 222 of the second group 600b may all have the same predefined function (which may in some examples also be the same as the predefined function of the grid components 222 of the first group 600a), or may have different predefined functions 550 to one another. Accordingly, transmitting the second altered electric power flow characteristic values may be by broadcasting the same second altered electric power flow characteristic values to all of the grid components 222 of the second group 600b, or for example by transmitting different second altered electric power flow characteristic values to different ones of the grid components according to their predefined function 550, as appropriate. Similarly, in some examples, the grid components of the first group 600a may have the same predefined function as the grid components of the second group 600b, or may have a different predefined function to the grid components of the second group 600b. In the latter case altering the second altered electric power flow characteristic values may comprise inputting the obtained electric power flow characteristic values to a second mapping function (not shown) that maps the different predefined function (not shown) onto the second controller function (not shown). In some examples, selecting the first group 600a of one or more grid components and/or selecting the second group 600b of one or more grid components may be based on an area in which the grid components are located. This may provide for a certain response to a change in electric power flow characteristic value to be provided in a certain area, or for different responses to be provided in different areas (e.g. different grid areas/locations and/or different geographical areas/regions/locations). For example, different areas or regions of the grid 200′ may have different inertia. For example, the grid frequency in an area of the grid 200′ with low inertia may change relatively rapidly in response to a given change in power consumption/provision balance. Accordingly, for grid components 222 in areas of the grid 200′ with low inertia, the controller function 552 on the basis of which altered frequency values are derived, may have a relatively small dead-band of frequency, in order to cause the grid component 222 to react relatively quickly to changes in measured frequency. As another example, a fault, such as an unexpected disconnection of a generator, may occur in a certain area of the grid. Accordingly, for grid components in 222 in the area of the grid 200′ in which the fault has occurred, the controller function may define a relatively aggressive response (e.g. a relatively large change in power for a given change in frequency), in order to cause those grid components to respond aggressively to the fault. For example, reactive power typically does not travel over long distances in the grid. A response to a drop in reactive power or voltage may therefore be best made by controlling grid components 222 in the same area as the drop in reactive power or voltage to provide an effective response.

In some examples, there may be a plurality of grid components 222a, 222b in the first group 600a and the grid components selected to be in the first group are located in the same area (e.g. grid area or geographical area) as one another. Similarly, there may be a plurality of grid components 222c, 222d in the second group 600b and the grid components selected to be in the second group 600b may be located in the same area (e.g. grid area or geographical area) as one another. This may allow for a coordinated response by a plurality of grid components 222 to be provided in a certain area, or for different coordinated responses to be provided in different areas.

In some examples, the first group 600a and/or the second group 600b of grid components may be selected based on at least one electric power flow condition in the area in which the grid components of the respective group are located. This may allow for a certain response (or responses) to be provided in a certain area (or areas) based on an electric power flow condition in that certain area (or areas). For example, as also described above, the electric power flow condition in a given area may comprise one or more of inertia of the area and a reactive power in the area. This may allow for a more tailored and/or granular response to be provided. As another example, the electric power flow condition may comprise an event propagation time, for example an estimate or forecast of the time it would take the impact of an event (such as a loss of a generator) to propagate across the area of a grid. For example, propagation may be faster in stronger areas of the grid having lower inertia, and slower in weaker areas of the grid with higher inertia. This may allow, for example, grid components to be selected to provide a response taking into account the propagation time. For example, for areas with a relatively small propagation time, grid components with a relatively fast response capability may be selected. This may provide for a tailored and/or more effective response to be provided.

In some examples, the first group 600a and/or the second group 600b of grid components may be selected based on the area in which the grid components of the respective group are located being an area in which a response to a change in grid condition of the electric power grid is determined to be required or is determined to be likely to be effective. This may allow for a response to be provided by grid components 222 in an area where a response is determined to be required or likely effective. For example, as described above, grid components 222 in the same area as where a fault has occurred (and/or where there is low inertia or reactive power) may be selected to provide an altered response, as this may be more effective than providing a response in an area remote from the fault. As another example, grid components 222 in an area where a response is likely to propagate effectively across the grid 200′ may be selected to provide the response. For example, areas of the grid having low inductance may allow reactive power to propagate relatively effectively.

In some examples, the first group 600a and/or the second group 600b of grid components may be selected based on the type of grid components. For example, the type of grid component may comprise one or more of a whether the grid component consumes or provides electric power, a power provision/consumption capacity of the grid component, a power provision/consumption capability of the grid component, such as speed of response, a mode of power consumption/provision of the grid component, a delay until power is consumed/provided by the grid component, an operational status of the grid component, one or more impact characteristics of the grid component (such as a response propagation time indicating an estimate or forecast of the time it would take a change in power provision/consumption to propagate across the grid, with prorogation being faster for grid components located in stronger areas of the grid with lower inertia), or any other characteristic of the grid component. For example, a group may be selected to include grid components that are of the same or similar type to one another. This may help provide a coordinated response from the group of power units. As another example, a group may be selected to include a mix of types of grid component, for example some grid components with lower provision/consumption capacity but with a low delay so as to provide a relatively small but fast initial response, as well as some grid components with a higher provision/consumption capacity but with a high delay so as to provide a relatively large follow up response. In any case, a more tailored and/or granular response may be provided.

As mentioned above, in some examples, the power that is consumed from and/or provided to the electric power grid by the one or more grid components may be reactive power. This may allow for responses to deviations in voltage, for example, to be provided.

As mentioned above, in some examples, at least the controller function 552 may comprises a dead-band of electric power flow characteristic value such that the one or more grid components 222 are controlled to consume power from and/or provide power to the electric power grid only when the obtained electric power flow characteristic value v is outside of the dead-band. This may allow for a dead-band to be implemented (or altered) by providing the altered electric power flow characteristic value to the grid components 222. This may allow for a stable response to be provided. This may be provided even for grid components 222 whose predefined function 550 does not necessarily include a dead-band.

Referring to FIG. 7, there is illustrated a system 700 comprising an apparatus 205. The apparatus 205 may be configured to perform a method according to any one of the examples described above with reference to FIGS. 1 to 6. For example, the apparatus 205 may be the controller 205 described above with reference to FIGS. 1 to 6, and/or may perform any one of the example functions of the controller 205 described above with reference to FIGS. 1 to 6. In this example, the system 700 comprises a grid component 222. For example, the grid component 222 may be configured to perform any one or more of the functions of any one of the examples of grid components 222 described above with reference to FIGS. 1 to 6. As also described above, in some examples, the system may comprise a plurality of grid components 222, which may be in separate groups and/or located in different areas of the grid 200, for example as described above with reference to FIGS. 1 to 6. In this example, the system 700 comprises a measurement device 220. In some examples, there may be a plurality of measurement devices 220, for example positioned at different areas of the grid, for example as described above with reference to FIGS. 1 to 6.

In this example, the apparatus 205 (hereinafter controller 205) comprises an input interface 718, a memory 714, a processor 712, and an output interface 716. The memory 714 may store a computer program comprising instructions which, when executed by the processor, cause the controller 205 to perform the method according to any one of the examples described above with reference to FIGS. 1 to 6. Further, there may be provided a computer readable medium storing instructions which, when executed by a computer (such as the controller 205) cause the computer to perform the method according to any one of the examples described above with reference to FIGS. 1 to 6.

The input interface 718 is configured to receive, from the measurement device 220, measurement data indicating one or more measured values of a characteristic of electric power flow in the electric power grid 200. The measurement data may be communicated via wired or wireless means. The input interface 718 may provide the measurement data to the processor 712, and thereby the processor 712 may obtain the electric power flow characteristic values.

The memory 714 may store the predefined function 550 of one or more grid components 222, one or more controller functions 552 according to which it is desired to control one or more of the grid components 222, and/or one or more mapping functions 554 each of which map a predefined function 550 onto a controller function 552.

The processor 712 may, in combination with the memory 714, alter the obtained electric power flow characteristic values to generate altered electric power flow characteristic values by inputting the obtained electric power flow characteristic values to a mapping function 554 that maps the predefined function 550 onto a controller function 552. For example, the mapping function 554 may be obtained from the memory 714. In some examples, the processor 712 may determine the predefined function 550 being employed by a selected one or more grid components 222, determine the controller function 552 according to which the selected one or more grid components are to be controlled, and determine the mapping function 554 that maps the determined predefined function 550 onto the determined controller function 552 (e.g. either by generating the mapping function from the predefined function 550 and the controller function 552, or by obtaining the appropriate mapping 554 function from memory 714, for example). In any case, the processor 712 may provide the altered electric power flow characteristic values to the output interface 716.

The output interface 716 may be configured to transmit the altered electric power flow characteristic values to the one or more grid components 222, thereby to control the one or more grid components 222 to consume power from and/or provide power to the electric power grid 200 according to the controller function 554. For example, the output interface 716 may be configured to transmit the altered electric power flow characteristic values to the one or more grid components 222 via wired or wireless means. For example, the output interface 716 may be configured to transmit the altered (and in some cases non-altered) electric power flow characteristic values to the one or more grid components 222 via a communications network such as the Internet 710. For example, each of the one or more grid components 222 may subscribe to a data stream of the controller 205, and may receive via this stream real-time or near real-time electric power flow characteristic values from the controller 205. When the controller 205 alters the electric power flow characteristic values in the manner described above, the data stream includes the altered electric power floe characteristic values, and as such the one or more grid components 222 receive those altered electric power flow characteristic values. Other means may be used to provide the electric power flow characteristic values from the controller 205 to the grid components 222. In addition to the altered electric power flow characteristic values, the output interface 716 may transmit other signals to the one or more grid components 222, as determined by the processor 712, for example the reparameterization signal and/or the selection signal, as described above.

In this example, the grid component 222 comprises an input interface 818, a memory 814, a processor 812, and a power consumer and/or provider 816. The input interface 318 is configured to receive electric power flow characteristic values from the controller 205 (as well as in some examples additional signals), for example in the manner descried above. The memory 314 may store the predefined function 550 (or in some examples a plurality of selectable predefined functions 550) according to which the grid component 222 is to consume/provide power to the grid 200. This predefined function 550 or the predefined functions may be pre-programmed into the grid component 222, for example on installation of the grid component and/or on registration of the grid component 222 as part of an ancillary service. For example, when a grid component 222 is registered, the memory 714 or other storage of the controller 205 may be updated with an identifier for the grid component 222 in association with the predefined function(s) 550 that the grid component has (and for example other information about the grid component such as its location, type, provision/consumption capacity etc.). For example, the other information may comprise the maximum capability of the grid component 222, for example the maximum provision/consumption capacity of the grid component 222 (or maximum capacity that is to be made available as part of the ancillary service), the maximum rate at which the grid component can change consumption and/or provision of electric power (or the maximum rate that is to be made available as part of the ancillary service), and the like. The controller 205 may then be configured to limit the controller function 552 and/or the mapping function 554 so as not to cause the grid component 222 to exceed these maxima. This may help ensure that grid components need not be tested and certified for use with a new controller function 552 every time a new controller function 552 is used.

The processor 812 may retrieve the predefined function 550 from the memory 314, input the received (altered) electric power flow characteristic value to the predefined function 550, and obtain the output of the function e.g. the power P that the grid component 222 is to consume from or provide to the electric power grid 200. The processor 312 may control the power consumer and/or provider 316 to consume or provide power to the grid 200 in accordance with the output of the function 550.

Accordingly, the one or more grid components 222 may consume power from and/or provide power to the electric power grid according to the controller function 552.

In some examples, the input interface 818 of the grid component 222 may receive, in addition to the altered electric power flow characteristic values, a local measurement of the electric power flow characteristic value. For example, the grid component may comprise or be associated with a measurement device (not shown in FIG. 7) that measures the electric power flow characteristic value at or in the vicinity of the grid component. In some examples, where the altered electric power flow characteristic values are not received by the grid component 222, for example due to communication issues such as internet connectivity issues, the grid component 222 may use instead the local measurement of electric power flow characteristic values. This may provide for a failover/failsafe capability of the grid component to continue operating, at least in some capacity, in case the altered electric power flow characteristic values are not received for some reason.

In some examples, each grid component 222 may consume power from and/or provide power to the electric power grid according to a predefined function that takes only one electric power flow characteristic value as an input. However, in other examples, the power consumption from and/or power provision to the electric power grid 200 by the grid component 222 may be based on received values of a plurality of different electric power flow characteristics. For example, in some examples the predefined function 550 may be a multidimensional function, taking the values of each of a plurality of different electric power flow characteristics as input. As another example, there may be a plurality of predefined functions 550 according to each of which a given grid component 222 is configured to consume electric power from and/or provide electric power to the electric power grid 200. For example, for a given grid component 222, a first predefined function (or a first dimension of a multidimensional predefined function) may take received values of a first electric power flow characteristic as input, and a second predefined function (or a second dimension of the multidimensional predefined function) may take received values of a second electric power flow characteristic value as input. For example, the first electric power flow characteristic may be grid frequency and the second electric power flow characteristic may be grid inertia (although it will be appreciated that any plurality of electric power flow characteristics may be used). For example, the grid component 222 may be a generator where the first predefined function/dimension may comprise a trigger value of frequency below which the generator 222 provides electric power to the electric power grid 200 and the second predefined function/dimension may comprise a trigger value of inertia below which the grid component 222 provides electric power to the electric power grid 200. For example, where either one or both of the trigger values have been met, the grid component 222 may provide electric power to the electric power grid (although it will be appreciated that, as above, each predefined function or the multidimensional predefined function may take any functional form). In such cases, or otherwise, values of a plurality of electric power flow characteristic values may be received by the grid component and used as an input for respective predefined functions or dimensions of the multidimensional predefined function. In such cases, or otherwise, the values of each of a plurality of electric power flow characteristics may be altered by the controller. For example, the values of each respective electric power flow characteristic may be altered by inputting obtained values for the respective electric power flow characteristic to a respective mapping function that maps the respective predefined function onto a respective controller function. As another example, the predefined function, the controller function, and the mapping function, may each be multidimensional. In these examples, the values of each respective electric power flow characteristic may be altered by inputting the obtained values for the respective electric power flow characteristic to a respective dimension of the mapping function that maps the predefined function onto the controller function. In some examples, the values of each of the plurality of electric power flow characteristics may be altered. However, in other examples, values of only one or more of the plurality of electric power flow characteristics may be altered.

Accordingly, in some examples, each grid component 222 may be configured to receive respective values of a plurality of electric power flow characteristics from a controller and consume power from and/or provide power to the electric power grid 200 according to a respective at least one predefined function, the at least one predefined function taking the received values of the plurality of the electric power flow characteristics as an input. In these cases, obtaining the measurement data as per step 102 may comprise obtaining data indicating one or more measured values of each of a plurality of said characteristics of electric power flow in the electric power flow grid. Altering the obtained electric power flow characteristic values as per step 104 may comprise altering the obtained values of each of the plurality of the electric power flow characteristics to generate altered values of each of the plurality of the electric power flow characteristics by inputting the obtained values of each of the plurality of the electric power flow characteristics to at least one mapping function that maps the at least one predefined function onto a at least one controller function. Transmitting the altered electric power flow characteristic values as in step 106 may comprise transmitting the altered values of the plurality of electric power flow characteristics to the one or more grid components, thereby to control the one or more grid components 222 to consume power from and/or provide power to the electric power grid 200 according to the at least one controller function. In the above described examples, the altered electric power flow characteristic values are transmitted to the one or more grid components 222, thereby to control the one or more grid components 222 to consume power from and/or provide power to the electric power grid 200 according to the controller function 552.

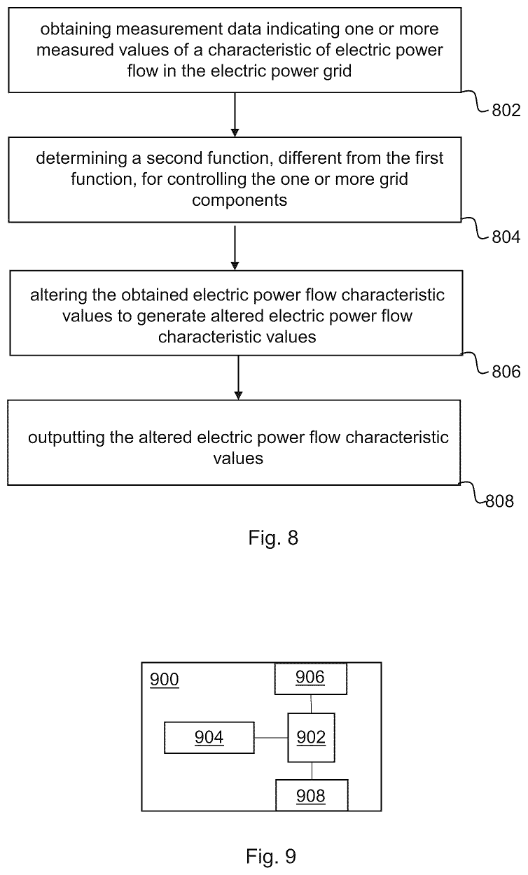

However, in some examples, the method need not necessarily comprise transmitting the altered electric power flow characteristic values to the one or more grid components 222. For example, there may be provided a method of providing altered electric power flow characteristic values v′, which altered electric power flow characteristic values v′ may have other uses. For example, referring to FIG. 8, there is illustrated a method of providing altered electric power flow characteristic values v′. For example, the method may be performed at a first entity (see e.g. the apparatus 900 of FIG. 9), which in some examples may be the controller 205 according to any one of the examples described above with reference to FIGS. 1 to 7, an in other examples may be any entity, such as a general purpose computer.

The method comprises, in step 802 obtaining measurement data indicating one or more measured values of a characteristic of electric power flow in an electric power grid 200. For example, the measurement data and/or the grid 200 may be the same or similar to those describe above with reference to FIGS. 1 to 7. One or more grid components 222 are each configured to consume electric power from and/or provide electric power to the electric power grid in accordance with a first function, based on received electric power flow characteristic values v. In some examples, the first function may be the predefined function 550 according to any one of the examples described above with reference to FIGS. 1 to 7.

The method comprises, in step 804, determining a second function, different from the first function, for controlling the one or more grid components 222 to consume electric power from and/or provide electric power to the electric power grid. For example, the second function may be the controller function 552 according to any one of the examples described above with reference to FIGS. 1 to 7. For example, as described above for the controller function 552, the second function may be provided or specified by a grid operator, and determining the second function may comprise obtaining the second function, for example from a grid operator. As another example, the second function may be determined based on a detected or forecasted change in a grid condition of the electric power grid, a specific time point in a time schedule being reached, a group to which the one or more grid components belong, a specific area in which the one or more grid components are located, and/or a grid condition in that specific area. For example, different second functions may be associated with respective different grid conditions, times, groups and/or areas, and determining the second function may comprise matching a detected or forecasted grid condition, a current time, a group to which the one or more grid components 222 belong and/or an area in which the one or more grid components are located, to the associated second function.

The method comprises, in step 806, altering the obtained electric power flow characteristic values v to generate altered electric power flow characteristic values v′ by inputting the obtained electric power flow characteristic values v to a mapping function that maps the first function onto the second function. For example, the mapping function may be the mapping function 554 according to any one of the examples described above with reference to FIGS. 1 to 7.

The method comprises, in step 808, outputting the altered electric power flow characteristic values. The output altered electric power flow characteristic values may be used in different ways (which may or may not include transmitting the output altered values to the one or more grid components 222 to control the one or more grid components according to the second function). For example, the method may comprise providing the altered electric power flow characteristic values to one or more components of a model of the electric power grid 200, thereby to simulate the behaviour of electric power flow in the grid that would result from transmitting the altered electric power flow characteristic values to the one or more grid components 222. This may allow a grid operator to simulate how the grid 200 would respond to when the altered values are transmitted to certain grid components. For example, the model may comprise a ‘digital twin’ of the electric power grid 200 and may model the behaviour of the grid 200. One or more components of the model may comprise one or more grid component models, which may model the behaviour of the grid components 222 in the grid 200. The altered electric power flow characteristic values may be provided as an input to the one or more grid component models, and the behaviour of the electricity flow in the grid resulting from this can be modelled. This may, for example, assist in the design of controller functions 554 that provide the most optimal response to changes in electric power flow characteristic value or grid condition of the grid 200.

In some examples, as described above, values of a plurality of electric power flow characteristics may be used, and there may be a respective plurality of first functions (or the first function may have a respective plurality of dimensions of electric power flow characteristic value). Accordingly, in some examples, obtaining the measurement data as per step 802 may comprise obtaining measurement data indicating one or more measured values of each of a plurality of characteristics of electric power flow in the electric power grid 200. Determining the second function as per step 804 may comprise determining at least one second function, different from the at least one first function, for controlling the one or more grid components 222 to consume electric power from and/or provide electric power to the electric power grid 200. Altering the obtained electric power flow characteristic values as per step 806 may comprise altering the obtained values of the plurality of the electric power flow characteristics to generate altered values of the plurality of the electric power flow characteristics by inputting the obtained values of the plurality of the electric power flow characteristics to at least one mapping function that maps the at least one first function onto the at least one second function. Outputting the altered electric power flow characteristics as per step 806 may comprise outputting the altered values of the plurality of electric power flow characteristics. Referring to FIG. 9, there is illustrated an apparatus 900 according an example. The apparatus may be configured to perform the method according to any of the examples described above with reference to FIG. 8. The apparatus 900 comprises a processor 902, a memory 904, an input interface 906 and an output interface 908. The memory 904 may store a computer program which, when executed by the processor 902 causes the processor to perform the method according to any of the examples described above with reference to FIG. 8. In some examples, the model of the electric power grid 200 may be executed also by the processor 902 and memory 904. In some examples, the model of the electric power grid may be executed by another device (not shown). In some examples, the input interface 906 may receive the measurement data, for example from a measurement device (not shown in FIG. 9) or from, for example, an output of the another device (not shown) executing the model of the grid 200. In some examples, the output interface 908 may output the altered electric power flow characteristic value, for example to the another device (not shown), or for example to the one or more grid components (not shown in FIG. 9).

The above examples are to be understood as illustrative examples of the invention. It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the invention, which is defined in the accompanying claims.

What is claimed is:

1. A method of controlling one or more grid components of an electric power grid, each grid component being arranged to consume electric power from and/or provide electric power to the electric power grid, each grid component being configured to receive respective electric power flow characteristic values from a controller and consume power from and/or provide power to the electric power grid according to a respective predefined function, the predefined function taking the received electric power flow characteristic values as an input, the method comprising, at the controller:
obtaining measurement data indicating one or more measured values of a characteristic of electric power flow in the electric power grid;
altering the obtained electric power flow characteristic values to generate altered electric power flow characteristic values by inputting the obtained electric power flow characteristic values to a mapping function that maps the predefined function onto a controller function; and
transmitting the altered electric power flow characteristic values to the one or more grid components, thereby to control the one or more grid components to consume power from and/or provide power to the electric power grid according to the controller function.

2. The method according to claim 1, wherein the predefined function defines a first trigger point of the electric power flow characteristic value at which the respective grid component is triggered to consume power from and/or provide power to the electric power grid, wherein the controller function defines a second trigger point of the electric power flow characteristic value different to the first trigger point, and wherein transmitting the altered electric power flow characteristic values to the one or more grid components triggers the one or more grid components to consume power from and/or provide power to the electric power grid when the obtained electric power flow characteristic value is at the second trigger point.

3. The method according to claim 1, wherein altering the obtained electric power flow characteristic values is responsive to a detected or forecasted change in a grid condition of the electric power grid.

4. The method according to claim 1, wherein the method comprises dynamically varying the alteration of the obtained electric power flow characteristic values in response to one or more detected or forecasted changes in a grid condition of the electric power grid.

5. The method according to claim 3, wherein the grid condition comprises an inertia, a short circuit ratio, a fault level and/or a system strength of the electric power grid; and/or a frequency, a voltage, a current, a reactive power, one or more oscillations, one or more harmonics, and/or a phase angle of electricity flowing in the electric power grid.

6. The method according to claim 4, wherein the grid condition comprises one or more oscillations of electricity flowing in the electric power grid and wherein dynamically varying the alteration comprises varying the alteration so as to dampen one or more of the oscillations.

7. The method according to claim 1, wherein altering the obtained electric power flow characteristic values is responsive to a time point in a time schedule being reached and/or wherein the method comprises dynamically varying the alteration of the obtained electric power flow characteristic values in response to one or more time points in a time schedule being reached.

8. The method according to claim 1, comprising:
transmitting, to the one or more grid components, in addition to the altered electric power flow characteristic values, a reparameterization signal configured to cause each of the one or more grid components to change one or more parameters of the predefined function according to which the grid component is configured to consume power from and/or provide power to the electric power grid.

9. The method according to claim 1, wherein each of the one or more grid components has a plurality of selectable predefined functions according to which the respective grid component is configurable to consume power from and/or provide power to the electric power grid, and wherein the method comprises:
transmitting to the one or more grid components, in addition to the altered electric power flow characteristic values, a selection signal configured to cause each of the one or more grid components to select, respectively, a predefined function of the plurality of predefined functions, whereby the respective grid component is configured to consume power from and/or provide power to the electric power grid according to the selected predefined function.

10. The method according to claim 1, wherein there are a plurality of the grid components.

11. The method according to claim 10, wherein the method comprises:
selecting a first group of one or more of the plurality of grid components; and
transmitting the altered electric power flow characteristic values to each grid component of the selected first group.

12. The method according to claim 11, wherein the method comprises:
selecting a second group of one or more of the plurality of grid components; and
transmitting second altered electric power flow characteristic values to each grid component of the second group of grid components, the second altered electric power flow characteristic values being obtained by inputting the obtained electric power flow characteristic values to a second mapping function that maps the predefined function onto a second controller function, thereby to control the second group of grid components to consume power from and/or provide power to the electric power grid according to the second controller function.

13. The method according to claim 11, wherein selecting the first group of one or more grid components and/or selecting the second group of one or more grid components is based on an area in which the grid components are located.

14. The method according to claim 13, wherein there is a plurality of grid components in the first group and the grid components selected to be in the first group are located in the same area as one another and/or wherein there is a plurality of grid components in the second group and the grid components selected to be in the second group are located in the same area as one another.

15. The method according to claim 13, wherein the first group and/or the second group of grid components are selected based on at least one electric power flow condition in the area in which the grid components of the respective group are located.

16. The method according to claim 15, wherein the first group and/or the second group of grid components are selected based on the area in which the grid components of the respective group are located being an area in which a response to a change in grid condition of the electric power grid is determined to be required or is determined to be likely to be effective.

17. The method according to claim 1, wherein obtaining the one or more electric power flow characteristic values comprises, at the controller:
obtaining a plurality of measurements of electric power flow characteristic values taken at a respective plurality of different locations in the electric power grid; and
combining the plurality of measurements to determine the obtained electric power flow characteristic values.

18. The method according to claim 1, wherein the electric power flow characteristic is indicative of one or more of a short circuit ratio, a fault level, and/or a system strength of the electric power grid; and/or a frequency, a voltage, a reactive power, one or more oscillations, one or more harmonics, and/or a phase angle, of electricity flowing in the electric power grid.

19. The method according to claim 1, wherein the power that is consumed from and/or provided to the electric power grid by the one or more grid components is reactive power.

20. The method according to claim 1, wherein at least the controller function comprises a dead-band of electric power flow characteristic value such that the one or more grid components are controlled to consume power from and/or provide power to the electric power grid only when the obtained electric power flow characteristic value is outside of the dead-band.

21. The method according to claim 1, wherein each grid component is configured to receive respective values of a plurality of electric power flow characteristics from a controller and consume power from and/or provide power to the electric power grid according to a respective at least one predefined function, the at least one predefined function taking the received values of the plurality of the electric power flow characteristics as an input;
wherein obtaining the measurement data comprises obtaining data indicating one or more measured values of each of a plurality of said characteristics of electric power flow in the electric power flow grid;
wherein altering the obtained electric power flow characteristic values comprises altering the obtained values of each of the plurality of the electric power flow characteristics to generate altered values of each of the plurality of the electric power flow characteristics by inputting the obtained values of each of the plurality of the electric power flow characteristics to at least one mapping function that maps the at least one predefined function onto a at least one controller function; and
wherein transmitting the altered electric power flow characteristic values comprises transmitting the altered values of the plurality of electric power flow characteristics to the one or more grid components, thereby to control the one or more grid components to consume power from and/or provide power to the electric power grid according to the at least one controller function.

22. A method of providing altered electric power flow characteristic values, the method comprising, at a first entity:
obtaining measurement data indicating one or more measured values of a characteristic of electric power flow in an electric power grid, wherein one or more grid components are each configured to consume electric power from and/or provide electric power to the electric power grid in accordance with a first function, based on received electric power flow characteristic values;
determining a second function, different from the first function, for controlling the one or more grid components to consume electric power from and/or provide electric power to the electric power grid;
altering the obtained electric power flow characteristic values to generate altered electric power flow characteristic values by inputting the obtained electric power flow characteristic values to a mapping function that maps the first function onto the second function; and
outputting the altered electric power flow characteristic values.

23. The method according to claim 22, wherein the method comprises:
providing the altered electric power flow characteristic values to one or more components of a model of the electric power grid, thereby to simulate the behaviour of electric power flow in the grid that would result from transmitting the altered electric power flow characteristic values to the one or more grid components.

24. The method according to claim 22, wherein obtaining the measurement data comprises obtaining measurement data indicating one or more measured values of each of a plurality of characteristics of electric power flow in an electric power grid, wherein one or more grid components are each configured to consume electric power from and/or provide electric power to the electric power grid in accordance with at least one first function, based on received values of the plurality of the electric power flow characteristics;
wherein determining the second function comprises determining at least one second function, different from the at least one first function, for controlling the one or more grid components to consume electric power from and/or provide electric power to the electric power grid;
wherein altering the obtained electric power flow characteristic values comprises altering the obtained values of the plurality of the electric power flow characteristics to generate altered values of the plurality of the electric power flow characteristics by inputting the obtained values of the plurality of the electric power flow characteristics to at least one mapping function that maps the at least one first function onto the at least one second function; and
wherein outputting the altered electric power flow characteristics comprises outputting the altered values of the plurality of electric power flow characteristics.

25. Apparatus configured to perform the method according to claim 1.

26. A computer program comprising instructions which, when executed by a computer, cause the computer to perform the method according to claim 1.

27. A system comprising the apparatus according to claim 25 and the one or more grid components.

28. A computer program comprising instructions which, when executed by a computer, cause the computer to perform the method according to claim 22.

29. Apparatus configured to perform the method according to claim 22.

30. A system comprising the apparatus according to claim 26 and the one or more grid components.
